(19) United States
(12) Patent Application Publication
(10) Pub. No.: US 2026/0003208 A1
(43) Pub. Date: Jan. 1, 2026

(54) EYEGLASSES FRAME WITH ADJUSTABLE NOSE PADS

(71) Applicant: HSIEN CHANG OPTICAL INDUSTRIAL CO.,LTD., TAINAN (TW)

(72) Inventor: Wen-Hsiung CHOU, TAINAN (TW)

(21) Appl. No.: 19/020,094

(22) Filed: Jan. 14, 2025

(30) Foreign Application Priority Data
Jun. 26, 2024 (TW) 113206779

(51) Int. Cl. G02C 5/12

(52) U.S. Cl. CPC G02C 5/122

(57) ABSTRACT

The present invention comprises an eyeglasses frame and nose bracket assemblies. The frame includes a nose-pad positioning seat located at the nose bridge. The nose bracket assemblies, situated on the nose-pad positioning seat, consist of a positioning rod, a coupling body, and a nose pad. The coupling body is sleeved over the positioning rod and has a coupling groove and fitting section. The nose pad is sleeved over the coupling body and include a slot. Through these components, the invention offers improved assembly and easier angle adjustment for nose pads.

### BACKGROUND OF THE INVENTION

### Field of the Invention

The invention relates to an eyeglasses frame with adjustable nose pads.

### Description of the Prior Art

Currently, most eyeglasses frames have centrally positioned nose pads, which are either fixed or adjustable. Adjustable nose pads are more ergonomic. However, due to variations in the height and width of users' nose bridges, the nose pads cannot properly fit the sides of nose bridges, leading to discomfort during wear.

### SUMMARY OF THE INVENTION

The objective of this invention is to offer nose pads with easier angle adjustment and improved stability.

The main characteristics of the invention provided an eyeglasses frame with adjustable nose pads, which comprises an eyeglasses frame, the eyeglasses frame includes a nose-pad positioning seat at the nose bridge, the nose-pad positioning seat has a upper and lower embedded grooves; a nose bracket assemblies, positioned on the nose-pad positioning seat, the nose bracket structure is provided with a positioning rod, a coupling body and a nose pad, the positioning rod includes a upper and lower inserting, and a pivot, the pivot has a locking teeth and a hook groove, the coupling body, is sleeved over the positioning rod, the coupling body provided a coupling groove and a fitting section, the coupling groove has a hook, and a curved stopping surface on the other side; the nose pad, is sleeved over the fitting section of coupling body, the nose pad comprises a slot.

### BRIEF DESCRIPTION OF DRAWINGS

This invention will be understood by referring to the accompanying drawings, wherein:

FIG. 1 is an exploded perspective view in the present invention.

FIG. 2 is an exploded perspective view of the positioning rod inserted into the nose-pad positioning seat in the present invention.

FIG. 3 is a perspective view in the present invention.

FIG. 4 is an exploded perspective view of the coupling body and the positioning rod.

FIG. 5 is an enlarged sectional view of the positioning rod inserted into the nose-pad positioning seat.

FIG. 6 is a top view of an engagement of the coupling body and the positioning rod.

FIG. 7 is a schematic view of angle adjustment between the coupling body and the positioning rod (nose pad not shown).

FIG. 8 is a schematic view of the coupling body and the positioning rod adjusted to another angle (nose pad not shown).

### DETAILED DESCRIPTION OF THE PREFERRED EMBODIMENT

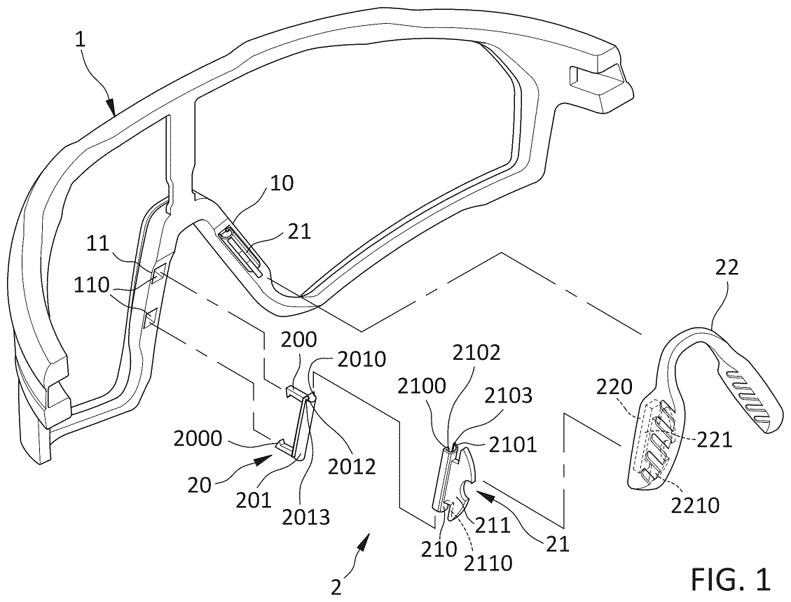

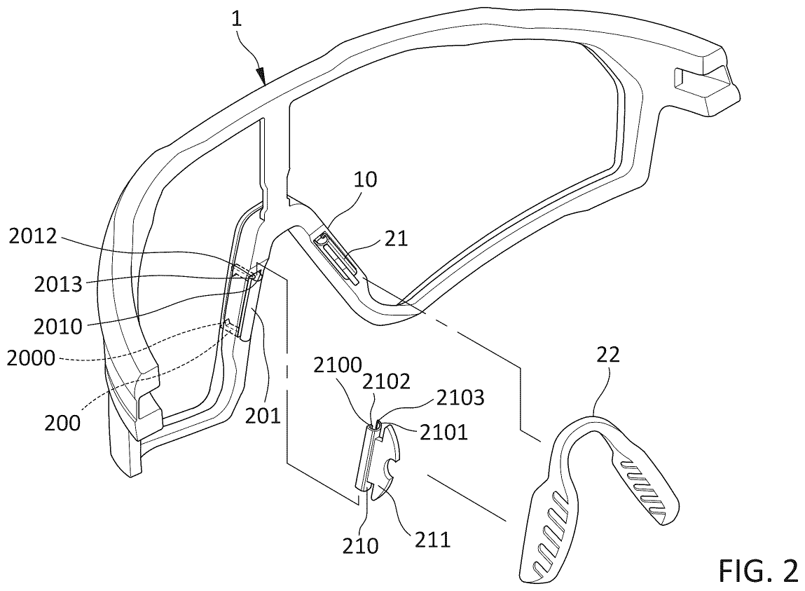

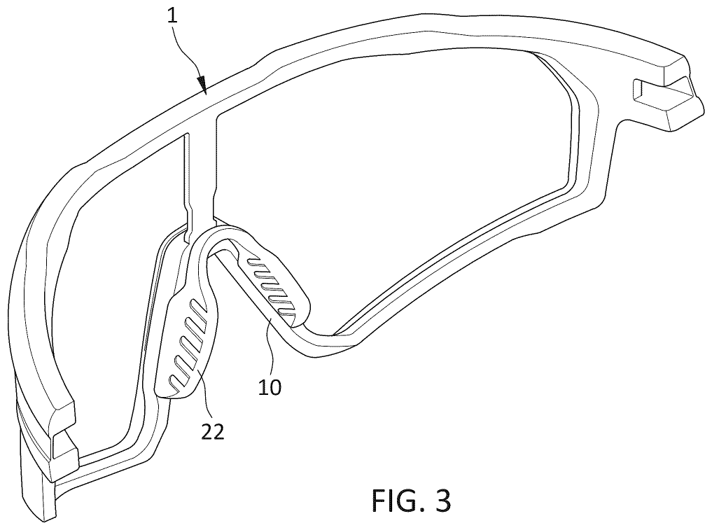

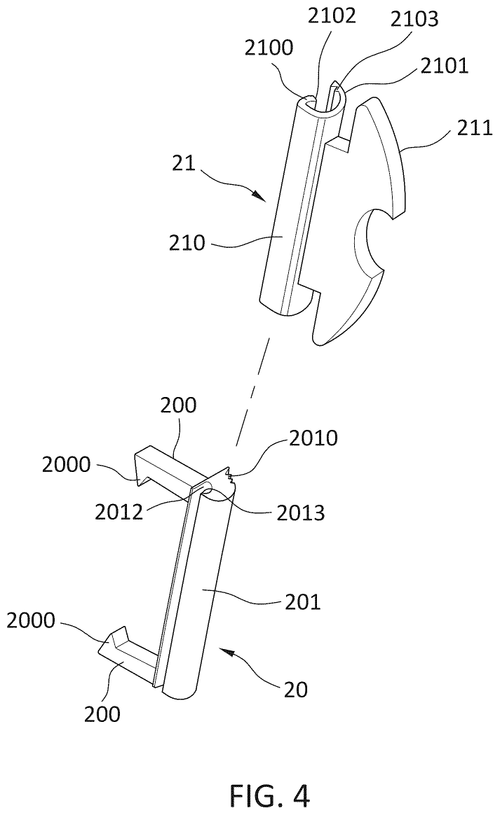

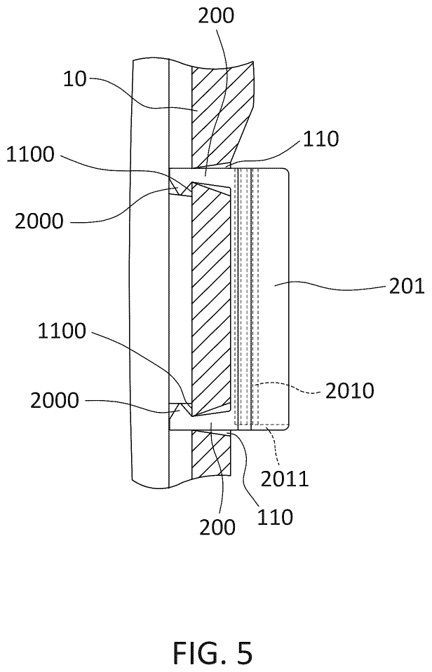

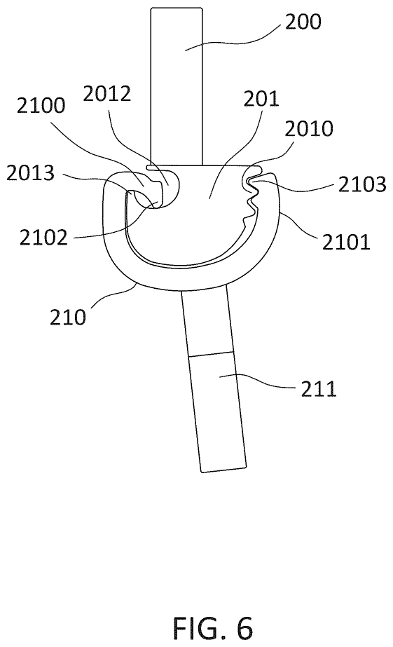

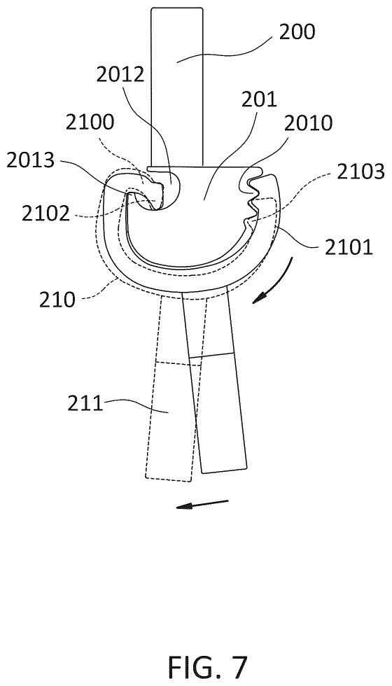

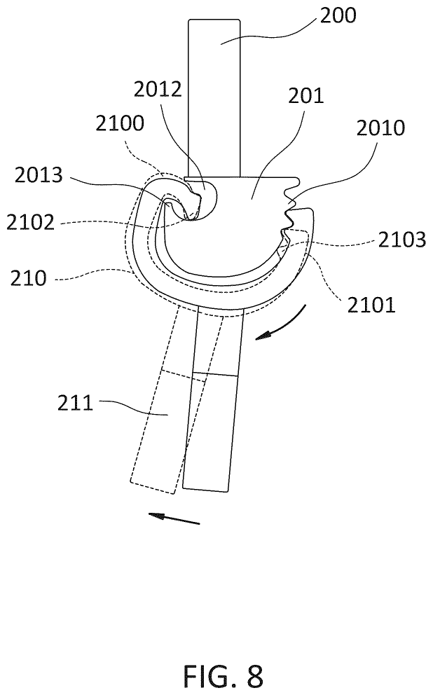

Referring to FIGS. 1 to 8, the example of the present invention mainly consists of an eyewear frame 1 and nose bracket assemblies 2. The eyeglasses frame 1 includes a nose-pad positioning seat 11 at the nose bridge 10, with upper and lower embedded grooves 110 at the nose-pad positioning seat 11. The base of the upper and lower embedded grooves 110 includes a stopping parts 1100. The nose bracket assemblies 2, positioned on the nose-pad positioning seat 11, comprise a U-shaped positioning rod 20, a coupling body 21, and a nose pad 22. The positioning rod 20 includes a upper and lower inserting 200 and a pivot 201. Each latch ends with a locking piece 2000. One side of the pivot 201 features multiple locking teeth 2010 with a stopper 2011 at the base, while the opposite side has a hook groove 2012 with a positioning structure 2013. The coupling body 21 is sleeved over the positioning rod 20 and includes a coupling groove 210 and a fitting section 211. The coupling groove 210 consists of two asymmetrical arc-shaped bodies formed by a hook 2100 and a curved stopping surface 2101. The hook 2100 ends with an anti-slip protrusion 2102, and the inner side of the curved stopping surface 2101 includes a engagement teeth 2103. The fitting section 211 at the top of the coupling body 21 is designed to tilt toward the curved stopping surface 2101, creating an asymmetrical coupling groove 210. The fitting section 211 has upper and lower retaining parts 2110. The nose pad 22, is made of elastic material, and sleeved over the coupling body 21. The surface of the nose pad 22 has a contact surface 220, and the lower part includes a slot 221 corresponding to the fitting section 211 of the coupling body 21, with a positioning groove 2210 at the end of the slot 221.

To assemble the present invention, the upper and lower inserting 200 of the positioning rod 20 are inserted into the upper and lower embedded grooves 110 of the nose-pad positioning seat 11. The locking piece 2000 is then locked and positioned in the stopping parts 1100 at the bottom of the upper and lower embedded grooves 110. Subsequently, the coupling body 21 is aligned with and inserted into the pivot 201 of the positioning rod 20 via the bottom of the coupling groove 210, allowing the hook 2100 to slot into the hook groove 2012 of the positioning rod 20. The engagement teeth 2103 of the coupling body 21 mesh securely with the locking teeth 2010 of the positioning rod 20, with the stopper at the bottom of the positioning rod 20, preventing detachment of the coupling body 21. Finally, the slot 221 of the nose pad 22 is aligned with and inserted into the fitting section 211 of the coupling body 21, completing the assembly of the nose pad 22. The engagement between the engagement teeth 2103 of the coupling body 21 and the locking teeth 2010 of the positioning rod 20 ensures stable angle adjustment of the nose pad 22, preventing unintended slippage.

Accordingly, the present invention has advantages below compared to the prior technical feathers.

The nose bracket assemblies'2 angle adjustment is achieved through a rigid combination of the positioning rod 20 and the coupling body 21, providing better precision and easier adjustment.

The connection between the positioning rod 20 and the lens frame 1 is ensured by the stopping parts 1100, which firmly lock the locking piece 2000 in the upper and lower embedded grooves 110, preventing detachment.

The nose pads 22 are adjusted to their optimal position, so that they rest securely on both sides of the user's nose bridge for enhanced comfort.

The angular adjustment between the coupling body 21 and the positioning rod 20 is facilitated by the locking mechanism of the hook groove 2012 and the hook 2100, allowing the engagement teeth 2103 and locking teeth 2010 to shift left or right. This feature enables fine-tuning of the nose pad 22 for greater comfort.

While the preferred embodiment of the invention has been described above, it will be recognized and understood that various modifications may be made therein and the appended claims are intended to cover all such modifications that may fall within the spirit and scope of the invention.

What is claimed is:

1. An eyeglasses frame with adjustable nose pads, which comprising:
an eyeglasses frame, said eyeglasses frame provided with a nose-pad positioning seat at the nose bridge, said nose-pad positioning seat includes a upper and lower embedded grooves; and
a nose bracket assemblies, positioned on said nose-pad positioning seat, said nose bracket assemblies provided with a positioning rod, a coupling body, and a nose pad, said positioning rod includes a upper and lower inserting, and a pivot, said pivot has a locking teeth and a hook groove; said coupling body, is sleeved over said positioning rod, said coupling body provided with a coupling groove and a fitting section, said coupling groove has a hook, and a curved stopping surface on the other side; said nose pad, is sleeved over said fitting section of said coupling body, said nose pad provided with a slot.

2. The eyeglasses frame with adjustable nose pads as claimed in claim 1, wherein said hook groove of said positioning rod has a positioning structure.

3. The eyeglasses frame with adjustable nose pads as claimed in claim 1, wherein said coupling groove includes a hook and a curved stopping surface, said curved stopping surface has multiple engagement teeth.

4. The eyeglasses frame with adjustable nose pads as claimed in claim 1, wherein said fitting section of said coupling body is designed to tilt toward said curved stopping surface.

5. An eyeglasses frame with adjustable nose pads, which comprising:
an eyeglasses frame, said eyeglasses frame provided with a nose-pad positioning seat at the nose bridge, said nose-pad positioning seat includes a upper and lower embedded grooves; and
a nose bracket assemblies, positioned on said nose-pad positioning seat, said nose bracket assemblies provided with a positioning rod, a coupling body, and a nose pad, said positioning rod includes a upper and lower inserting, and a pivot; said coupling body, is sleeved over said positioning rod, said coupling body provided with a coupling groove and a fitting section, said nose pad, is sleeved over said fitting section of said coupling body, said nose pad provided with a slot;
wherein said pivot has a locking teeth and a hook groove, said coupling groove has a hook, and a curved stopping surface on the other side.
